(19) United States
(12) Patent Application Publication
(10) Pub. No.: US 2013/0267295 A1
(43) Pub. Date: Oct. 10, 2013

(54) MULTILAYER DISPLAY WITH PARALLAX CORRECTION

(71) Applicants: Anthony Frabbiele, Reno, NV (US); Chauncey Griswold, Reno, NV (US); Stewart Thoeni, Reno, NV (US)

(72) Inventors: Anthony Frabbiele, Reno, NV (US); Chauncey Griswold, Reno, NV (US); Stewart Thoeni, Reno, NV (US)

(73) Assignee: IGT, Reno, NV (US)

(21) Appl. No.: 13/443,770

(22) Filed: Apr. 10, 2012

(51) Int. Cl. A63F 13/00

(52) U.S. Cl. 463/16; 463/33

(57) ABSTRACT

Techniques for removing the parallax effect on multilayer displays in gaming machines. A gaming machine includes a multilayer display, a player sensor, and one or more processors. The multilayer display includes a proximate display and a distal display. The player sensor detects data associated with a person indicating the person's viewing position of the multilayer display. The one or more processors use the data to determine whether a correction for parallax is required. The image on the proximate display, the distal display or both may be modified based on the data to provide a composite image on the multilayer display without the parallax effect for the person at the person's viewing position of the multilayer display.

### TECHNICAL FIELD

The present disclosure relates generally to wager-based gaming machines, and more specifically to methods and devices for providing a multilayer display on a wager-based gaming machine.

### BACKGROUND

Typically, utilizing a master gaming controller, a gaming machine controls various combinations of devices that allow a player to play a wager game on the gaming machine and also encourage game play on the gaming machine. For example, a wager game played on a gaming machine usually requires a player to input money or indicia of credit into the gaming machine, indicate a wager amount, and initiate a game play. These steps require the gaming machine to control payment devices, including bill validators and coin acceptors, to accept money into the gaming machine and recognize user inputs from user interfaces, including key pads and button pads, to determine the wager amount and initiate game play. After game play has been initiated, the gaming machine determines a wager game outcome, presents the game outcome to the player and may dispense an award of some type depending on the outcome of the wager game.

Despite the existence of gaming machines that virtually represent spinning reels on a single video display, many players prefer a traditional gaming machine with mechanical spinning reels behind a reel glass. Therefore, gaming machines may use multilayer displays, rather than the single video display, to virtually present the visual depth of the spinning reels behind the reel glass.

A multilayer display may include two displays. A first display may be positioned directly in front of a player and may be used to display data traditionally represented on the reel glass. Examples of such data include potential wager game outcomes, player tracking data, game information, credit information, or data associated with bonusing or progressives. A second display may be positioned behind the first screen and may be used to represent the spinning reels. The first display may include transparent or cut-out regions so that the second display, e.g. the spinning reels, is viewable through these regions. The second display is typically positioned parallel to, and approximately an inch behind, the first display to create a sense of depth, i.e., the illusion of mechanical spinning reels behind a reel glass.

Because of the distance between the two displays, a parallax effect may cause graphics on the front display and graphics on the back display to no longer line up correctly if a player's head or eyes move away from an ideal viewing position. For instance, moving to the left of the ideal viewing position may create the illusion of the front display shifting more to the right than the back display, revealing some regions of the back display that should be covered and covering other regions of the back display that should be viewable. A parallax effect may also be caused by factors other than player movement such as multilayer display height (e.g., is the gaming machine placed on a raised surface), player height, seat height, horizontal seat location relative to the multilayer display, or player distance from the multilayer display. Many or all of these factors may not be within the control of the gaming machine or multilayer display manufacturer.

For the foregoing and other reasons, it would be desirable to provide novel methods and devices for removing the parallax effect on multilayer displays in gaming machines.

### SUMMARY

Various embodiments described or referenced herein are directed to gaming machines and methods implementing and using techniques for removing the parallax effect on multilayer displays in gaming machines.

In some implementations, a gaming machine may include a multilayer display, a player sensor, and one or more processors. The multilayer display includes a proximate display and a distal display. The player sensor is configured to detect data associated with a person indicating the person's viewing position of the multilayer display. The one or more processors are configured to provide wager game play on the gaming machine, generate a default proximate image and a default distal image. The one or more processors are further configured to receive the data indicating the person's viewing position of the multilayer display and determine whether a correction for a parallax effect is required based on the data indicating the person's viewing position. Responsive to determining the correction is required, the one or more processors are further configured to either (a) generate a modified proximate image by modifying the default proximate image based on the data indicating the person's viewing position, and send the modified proximate image to the proximate display, or (b) generate a modified distal image by modifying the default distal image based on the data indicating the person's viewing position, and send the modified distal image to the distal display. The proximate display and the distal display provide a composite image on the multilayer display without the parallax effect for the person at the person's viewing position of the multilayer display.

In some implementations, the one or more processors of the gaming machine may be further configured to, responsive to determining the correction for parallax is required, (a) generate the modified proximate image by modifying the default proximate image based on the data indicating the person's viewing position and send the modified proximate image to the proximate display, and (b) generate the modified distal image by modifying the default distal image based on the data indicating the person's viewing position and send the modified distal image to the distal display.

In some implementations, the one or more processors of the gaming machine may be further configured to generate the modified proximate image by adjusting the default proximate image's position or size, to generate the modified distal image by adjusting the default distal image's position or size, or both.

In some implementations, the player sensor may be an image sensor such as an optical sensor, TOF camera, ultra-sonic, infrared, laser or radar.

In various implementations, the data associated with the person may include data associated with the person's head location, data associated with the person's eye location or data associated with the person's gaze direction.

In some implementations, the modified proximate image includes a graphical representation of a virtual reel glass and the modified distal image includes a graphical representation of spinning reels.

In some implementations, the gaming machine may further include a touch screen. In some implementations, the one or more processors may be configured to receive a touch screen input including data indicating one or more locations on the touch screen determine a response to the touch screen input by mapping the one or more locations to the modified proximate image or the modified distal image. In some implementations, the one or more processors may be configured to determine a response to the touch screen input by mapping the one or more locations to the modified proximate image and the modified distal image.

In some implementations, a method provides for correcting for parallax effects on a gaming machine including a multilayer display and a distal display. The method may include generating, with one or more processors, a default proximate image; generating, with the one or more processors, a default distal image; receiving data associated with a person indicating the person's viewing position of the multilayer display from a player sensor; determining whether a correction for a parallax effect is required based on the data indicating the person's viewing position; responsive to determining the correction is required, either: (a) generating, with the one or more processors, a modified proximate image by modifying the default proximate image based on the data indicating the person's viewing position, and sending the modified proximate image to the proximate display, or (b) generating, with the one or more processors, a modified distal image by modifying the default distal image based on the data indicating the person's viewing position, and sending the modified distal image to the distal display; and wherein the proximate display and the distal display provide a composite image on the multilayer display without a parallax effect for the person at the person's viewing position of the multilayer display.

In some implementations, the method may further include, responsive to determining the correction is required: generating, with the one or more processors, a modified proximate image by modifying the default proximate image based on the data indicating the person's viewing position, sending the modified proximate image to the proximate display, generating, with the one or more processors, a modified distal image by modifying the default distal image based on the data indicating the person's viewing position, and sending the modified distal image to the distal display.

In some implementations, the method may further include generating the modified proximate image by adjusting the default proximate image's position or size.

In some implementations, the method may further include generating the modified distal image by adjusting the default distal image's position or size.

In some implementations, the player sensor may be an image sensor such as an optical sensor, TOF camera, ultra-sonic, infrared, laser, or radar.

In various implementations, the data associated with the person may be data associated with the person's head location, data associated with the person's eye location or data associated with the person's gaze direction.

In some implementations, the method may further include: receiving a touch screen input from a touch screen, the touch screen input including data indicating one or more locations on the touch screen; and determining a response to the touch screen input by mapping the one or more locations to the modified proximate image or the modified distal image.

In some implementations, the method may further include receiving a touch screen input from a touch screen, the touch screen input including data indicating one or more locations on the touch screen; and determining a response to the touch screen input by mapping the one or more locations to the modified proximate image and the modified distal image.

In some implementations, the modified proximate image includes a graphical representation of a virtual reel glass and the modified distal image includes a graphical representation of spinning reels.

In some implementations, a gaming machine provides for substantially correcting parallax on a multilayer display for multiple viewers. The gaming machine may include a multilayer display, a player sensor and one or more processors. The multilayer display may include a proximate display and a distal display. The player sensor may be configured to detect first data associated with a first person indicating the first person's viewing position of the multilayer display and detect data associated with a second person indicating the second person's viewing position of the multilayer display. The one or more processors may be configured to: provide wager game play on the gaming machine, generate a default proximate image, generate a default distal image, receive the first data indicating the first person's viewing position of the multilayer display, receive the second data indicating the second person's viewing position of the multilayer display, determine an average viewing position using the first data and the second data; determine whether a correction for a parallax effect is required based on the average viewing position, responsive to determining the correction is required, either: (a) generate a modified proximate image by modifying the default proximate image based on the average viewing position, and send the modified proximate image to the proximate display, or (b) generate a modified distal image by modifying the default distal image based on the average viewing position, and send the modified distal image to the distal display. The proximate display and the distal display are generated such that they provide a composite image on the multilayer display without a parallax effect for a person at the average viewing position.

Aspects of the invention may be implemented by networked gaming machines, game servers and other such devices. These and other features and benefits of aspects of the invention will be described in more detail below with reference to the associated drawings. In addition, other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and process steps for the disclosed subject matter. These drawings in no way limit any changes in form and detail that may be made to implementations by one skilled in the art without departing from the spirit and scope of the disclosure.

FIGS. 1, 2A, and 2B show perspective diagrams of an example of a gaming machine, configured in accordance with some implementations.

FIG. 3 shows an example of a gaming machine 300 including a multilayer display, configured in accordance with some implementations

FIG. 4 shows an exemplary display 400 that may be provided by a multilayer display, configured in accordance with some implementations.

FIG. 5 illustrates an example control system for the gaming machine 300, configured in accordance with some implementations.

FIG. 6 shows a flowchart of an example of a method 600 for correcting parallax on a multilayer display, performed in accordance with some implementations.

FIG. 7 shows a flowchart of an example of a method 700 for correcting parallax on a multilayer display having a touch screen, performed in accordance with some implementations.

FIG. 8A shows a representation of the player's line of sight of the multilayered display from a standard viewing position.

FIG. 8B shows a representation of the player's line of sight of the multilayered display after the player has moved below the standard viewing position along a Y-axis.

FIG. 8C shows a representation of the player's line of sight of the multilayered display after correcting for the player having moved below the standard viewing position along a Y-axis.

FIG. 8D shows a representation of the player's line of sight of the multilayered display after correcting for the player having moved below the standard viewing position along a Y-axis.

FIG. 9A shows a representation of the player's line of sight of the multilayered display after the player has moved toward the multilayered display from the standard viewing position along a Z-axis.

FIG. 9B shows a representation of the player's line of sight of the multilayered display after the player has moved away from the multilayered display from the standard viewing position along a Z-axis.

FIG. 10 shows a flowchart of an example of a method 1000 for substantially correcting parallax on a multilayer display for multiple viewers, performed in accordance with some implementations.

### DETAILED DESCRIPTION

Applications of gaming machines and methods according to one or more implementations are described in this section. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosure, it is understood that these examples are not limiting, such that other implementations or embodiments may be used and changes may be made without departing from the spirit and scope of the invention as defined by the appended claims.

The present subject matter provides gaming machines and methods implementing and using techniques for removing the parallax effect on multilayer displays in gaming machines. Although the current description primarily describes slot-type gaming machines, some implementations of the invention apply equally to similar types of machines that use multilayer displays.

Structure of the Gaming Machine

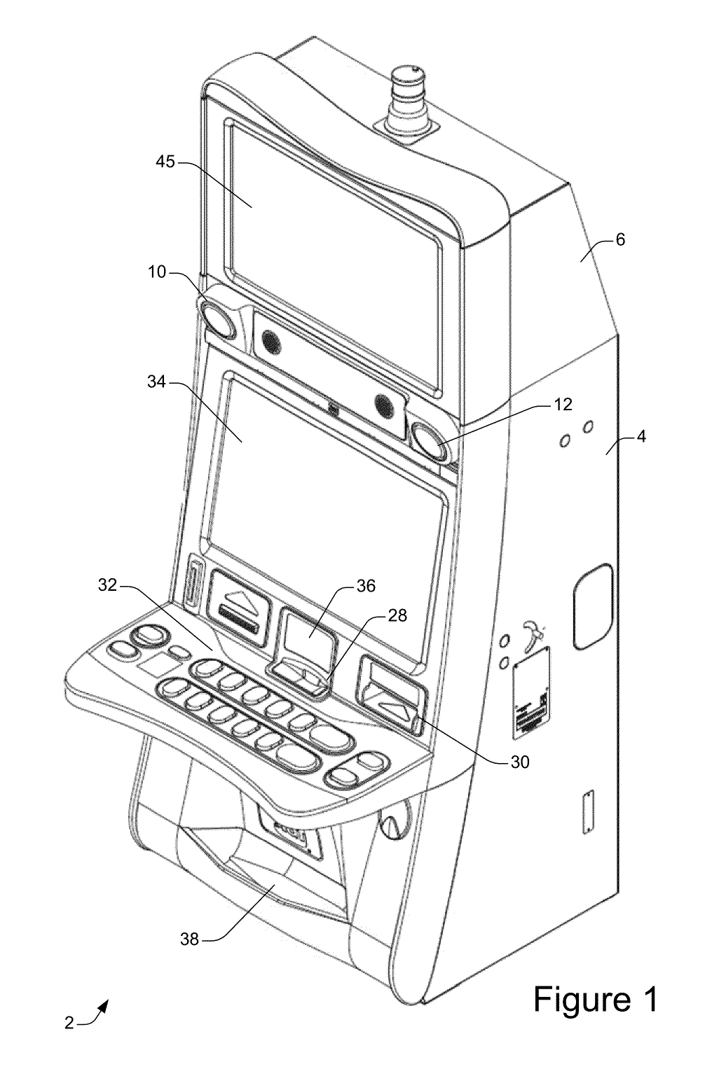

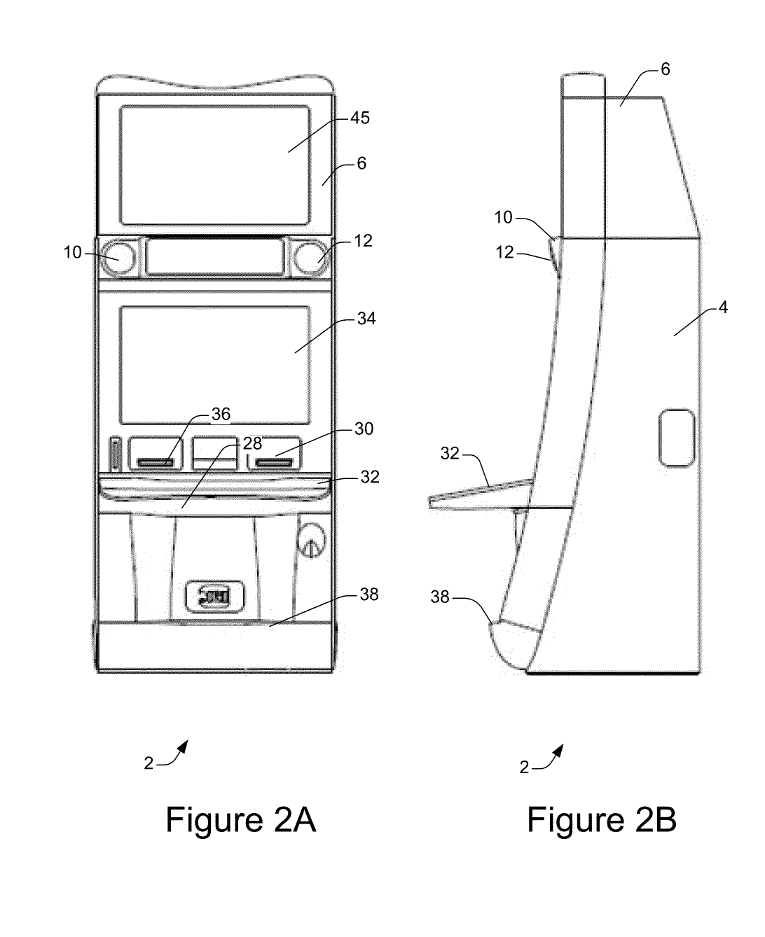

FIGS. 1, 2A, and 2B show perspective diagrams of an example of a gaming machine 2, configured in accordance with some implementations. As illustrated in FIGS. 1, 2A, and 2B, the gaming machine 2 includes a gaming machine main cabinet 4, which generally surrounds the machine interior and is viewable by users.

In some implementations, the gaming machine may include any of a plurality of devices. For example, the gaming machine may include a ticket printer that prints bar-coded tickets, a key pad for entering player tracking information, a display 34, a card reader for entering a magnetic striped card containing player tracking information, and any other devices. The ticket printer may be used to print tickets for a cashless ticketing system. In FIGS. 1, 2A, and 2B, attached to the main door is a payment acceptor 28, a bill validator 30, and a coin tray 38. The payment acceptor may include a coin slot and/or a payment, note, or bill acceptor, where the player inserts money, coins, tokens, or other types of payments.

In some implementations, devices such as readers or validators for credit cards, debit cards, smart cards, or credit slips may facilitate payment. For example, a player may insert an identification card into a card reader of the gaming machine. The identification card may be a smart card coded with a player's identification, credit totals (or related data) and other relevant information. As another example, a player may carry a portable device, such as a cell phone, a radio frequency identification tag or any other suitable wireless device. The portable device may communicates a player's identification, credit totals (or related data), and/or any other relevant information to the gaming machine. As yet another example, money may be transferred to a gaming machine through electronic funds transfer. When a player funds the gaming machine, a logic device coupled to the gaming machine may determine the amount of funds entered and display the corresponding amount on a display device.

In some implementations, attached to the main door is a plurality of player-input switches or buttons 32. The input switches can include any suitable devices which enables the player to produce an input signal which is received by the processor. The input switches may include a game activation device that may be used by the player to start any primary game or sequence of events in the gaming machine. The game activation device can be any suitable play activator such as a “bet one” button, a “max bet” button, or a “repeat the bet” button. In some instances, upon appropriate funding, the gaming machine may begin the game play automatically. Alternately, the gaming machine may automatically activate game play after detecting user input via the game activation device.

In some implementations, one input switch is a cash-out button. The player may push the cash-out button and cash out to receive a cash payment or other suitable form of payment corresponding to the number of remaining credits. For example, when the player cashes out, the player may receive the coins or tokens in a coin payout tray. As another example, the player may receive other payout mechanisms such as tickets or credit slips redeemable by a cashier (or other suitable redemption system) or funding to the player's electronically recordable identification card. As yet another example, funds may be transferred from the gaming machine to the player's smart card, or other electronic wallet device.

In some implementations, one input switch is a touch-screen coupled with a touch-screen controller, or some other touch-sensitive display overlay to enable for player interaction with the images on the display. The touch-screen and the touch-screen controller may be connected to a video controller. A player may make decisions and input signals into the gaming machine by touching the touch-screen at the appropriate places. One such input switch is a touch-screen button panel.

In some implementations, the gaming machine may include communication ports for enabling communication of the gaming machine processor with external peripherals, such as external video sources, expansion buses, game or other displays, a SATA port, a key pad, or a network interface for communicating via a network.

In some implementations, the gaming machine may include a top box. For example, the gaming machine 2 includes a top box 6, which sits on top of the main cabinet 4. The top box 6 may house any of a number of devices, which may be used to add features to a game being played on the gaming machine 2. These devices may include speakers 10 and 12, display device 45, and other devices. Further, the top box 6 may house different or additional devices not illustrated in FIGS. 1, 2A, and 2B. For example, the top box may include a bonus wheel or a back-lit silk screened panel which may be used to add bonus features to the game being played on the gaming machine. As another example, the top box may include a display for a progressive jackpot offered on the gaming machine. As yet another example, the top box may include a smart card interaction device. During a game, these devices may be controlled and powered, at least in part, by circuitry (e.g. a master gaming controller) housed within the main cabinet 4 of the gaming machine 2.

In some implementations, speakers (or an “audio device”) may be mounted and situated in the main cabinet 4 with an angled orientation toward the player. For instance, the speakers 10 and 12 located in the main cabinet 4 of the upper region of the gaming machine 2 may be mounted and situated in the cabinet with an angled orientation down towards the player and the floor. In one example, the angle is 45 degrees with respect to the vertical, longitudinal axis of the machine 2. In another example, the angle is in a range of 30-60 degrees. In another example, the angle is any angle between 0 and 90 degrees. In some implementations, the angle of speakers in the gaming machine may be adjustable. For instance, speakers, displays, button panels, bill acceptors, card readers or other interface devices may be adjusted to face in a direction more closely approximating an estimated position of a player's head or facial features.

The bill validator 30, player-input switches 32, display screen 34, and other gaming devices may be used to present a wager game on the game machine 2. The devices may be controlled by code executed by a master gaming controller housed inside the main cabinet 4 of the machine 2. The master gaming controller may include one or more processors including general purpose and specialized processors, such as graphics cards, and one or more memory devices including volatile and non-volatile memory. The master gaming controller may periodically configure and/or authenticate the code executed on the gaming machine.

In some implementations, the gaming machine may include, as noted, a sound generating device coupled to one or more sounds cards. The sound generating device may include one or more speakers or other sound generating hardware and/or software for generating sounds, such as playing music for the primary and/or secondary game or for other modes of the gaming machine, such as an attract mode. The gaming machine may provide dynamic sounds coupled with attractive multimedia images displayed on one or more of the display devices to provide an audio-visual representation or to otherwise display full-motion video with sound to attract players to the gaming machine. During idle periods, the gaming machine may display a sequence of audio and/or visual attraction messages to attract potential players to the gaming machine. The videos may also be customized for or to provide any appropriate information.

In some implementations, the gaming machine may include one or more display devices. For example, the gaming machine 2 includes the display 34 and an information panel 36. The display 34 and the information panel 36 may each include one or more of a cathode ray tube, an LCD, a light emitting diode (LED) based display, an organic light emitting diode (OLED) based display, a polymer light emitting diode (PLED) based display, an SED based-display, an E-ink display, a plasma display, a television display, a display including a projected and/or reflected image, or any other suitable electronic display device.

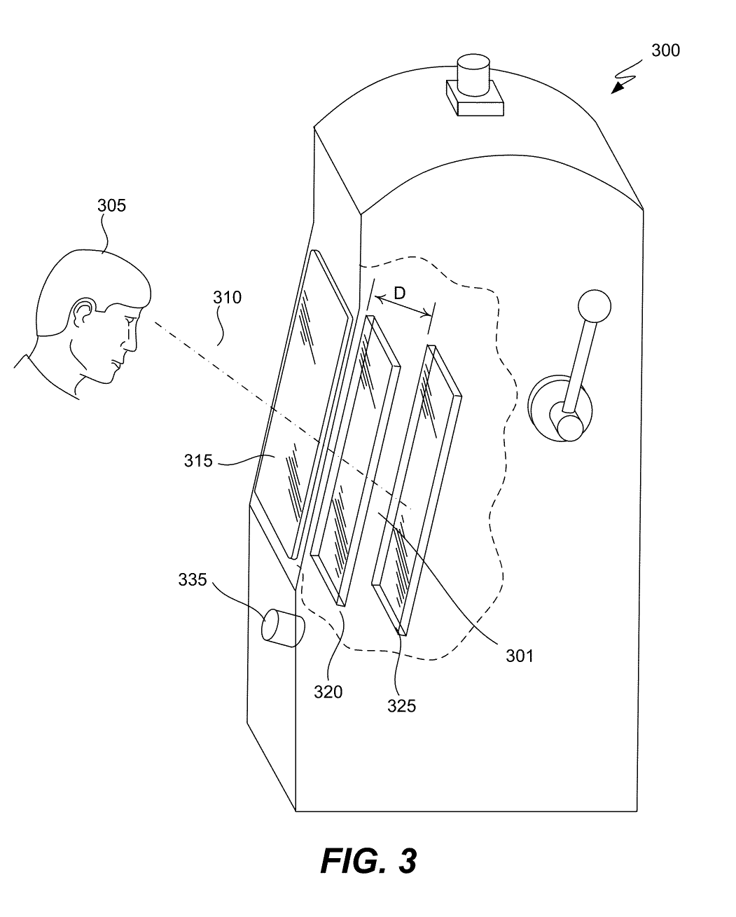

FIG. 3 shows an example of a gaming machine 300 wherein the display 34 is a multilayer display 301, configured in accordance with some implementations. The gaming machine 300 may contain some or all of the features of the gaming machine 2 shown in FIGS. 1, 2A and 2B. The gaming machine 300 may further include a player sensor device (or “player sensor”) 335. The multilayer display may include a proximate display 320 and a distal display 325 arranged in a common line of sight 310 relative to a player 305 viewing the gaming machine. The proximate display 320 is referred to as “proximate” because it is closer to the player along the common line of site than the distal display 325, referred to as “distal.” The displays 320 and 325 may be stacked in parallel and separated for depth by a distance D. The distance D may be typically around one inch, although a person of skill in the art will appreciate that the exact size of D will be mostly a matter of design preference. For instance, D may be larger to create a greater sense of depth or smaller to create a smaller sense of depth.

The terms “player,” “viewer” or “person” as used herein, should not be construed as limiting the techniques and structures disclosed for removing the parallax effect to only persons actively engaging in a gaming session on the gaming machine. The techniques and structures for removing the parallax effect are applicable to any viewer or any plurality of users of the multilayer display.

The proximate display may be adaptable to be completely or partially transparent or translucent in various regions so as to permit view of distal display. While the multilayer display 301 shown in FIG. 3 includes two layered displays, those of skill in the art will appreciate that techniques for removing the parallax effect apply to multilayer displays including two or more layered displays. Techniques and structures implementing transparent or translucent layered displays are described in U.S. application Ser. No. 11/514,808, filed on Sep. 1, 2006 (Attorney docket. No. IGT1P194/P001085-002), naming Wells, et al. as inventors, and titled, “Gaming Machine with Layered Displays;” which is incorporated herein by reference and in its entirety.

In some implementations, the layered displays may be configured to receive one or more signals encoding data for a visual image from a processor or controller of the gaming machine. The layered display may use the one or more signals to display the graphics and images of a game. The format of a signal may depend on the display device. In one example, all the layered displays may be configured to respond to digital signals. For example, the red, green and blue pixilated light transmission elements for an LCD device typically respond to digital control signals to generate colored light, as desired. In another example, the layered displays may be configured to respond to various digital and analog signals and in various signal formats.

In some implementations, the processor or controller of the gaming machine sends a single signal to the layered displays. The single signal includes data for a single graphical image, half of which is presented on the proximate display and half on the distal display. In another example, the single signal may include data for two graphical images, one of which is presented on the proximate display and the other which is presented on the distal display.

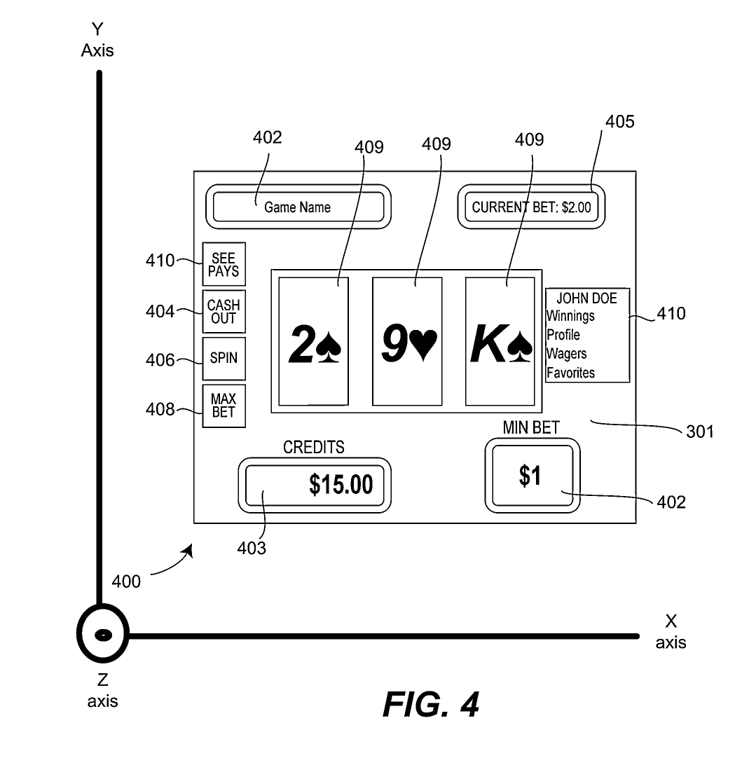

In some implementations, the layered displays may be operable to digitally represent a gaming machine with spinning reels behind a reel glass. FIG. 4 shows an exemplary display 400 that may be provided by the multilayer display 301, configured in accordance with some implementations. The distal display 325 may digitally represent spinning reels 409. The spinning reels present an outcome for a wager game, e.g. a slot game, to the player.

The proximate display 320 may be configured to present a “virtual reel glass,” including information other than a wager game or a wager game outcome. For instance, the proximate display may present as part of the virtual reel glass player tracking data 410, game information 402, player credit information 403, wager amount 405, service menus (not shown), advertisements (not shown), attraction sequences (not shown), or data associated with bonusing or progressives (not shown). The proximate display may further provide user interactive images of a plurality of player selectable buttons to allow the player to control the play of the slots game. The buttons may include a “See Pays” button 410, a “Cash Out” button 404, a “Spin” button 406, and a “Max Bet” button 408. The buttons may be communicatively coupled with a touch screen, such as touch screen 315 shown in FIG. 3, configured to receive inputs to provide user interactivity with the gaming machine.

In some implementations, the layered displays may digitally present a gaming machine other than a slot machine. For instance, the layered displays may present wager games involving one or more rotatable wheels or dice. In some implementations, the layered displays may be configured to present three-dimensional (3D) graphics. The gaming machine may use a combination of virtual 3D graphics on any one of the display devices—in addition to 3D graphics obtained using the different depths of the layered displays. Virtual 3D graphics on a single screen typically involve shading, highlighting and perspective techniques that selectively position graphics in an image to create the perception of depth. These virtual 3D image techniques cause the human eye to perceive depth in an image even though there is no real depth (the images are physically displayed on a single display screen, which is relatively thin). In another example, the distance D (between the proximate and distal displays) may facilitate the creation of graphics having real depth between the layered displays. 3D presentation of graphic components may then use a combination of: a) virtual 3D graphics techniques on one or more of the multiple screens and/or b) the depths between the layered display devices.

The preceding implementations are merely examples of types of images, animations, graphics, video, or content that may be provided by the layered displays of the gaming machine. Those of skill in the art will appreciate that the techniques described herein for removing the parallax effect may have broad application to multilayer displays not tied to any specific content or gaming machines.

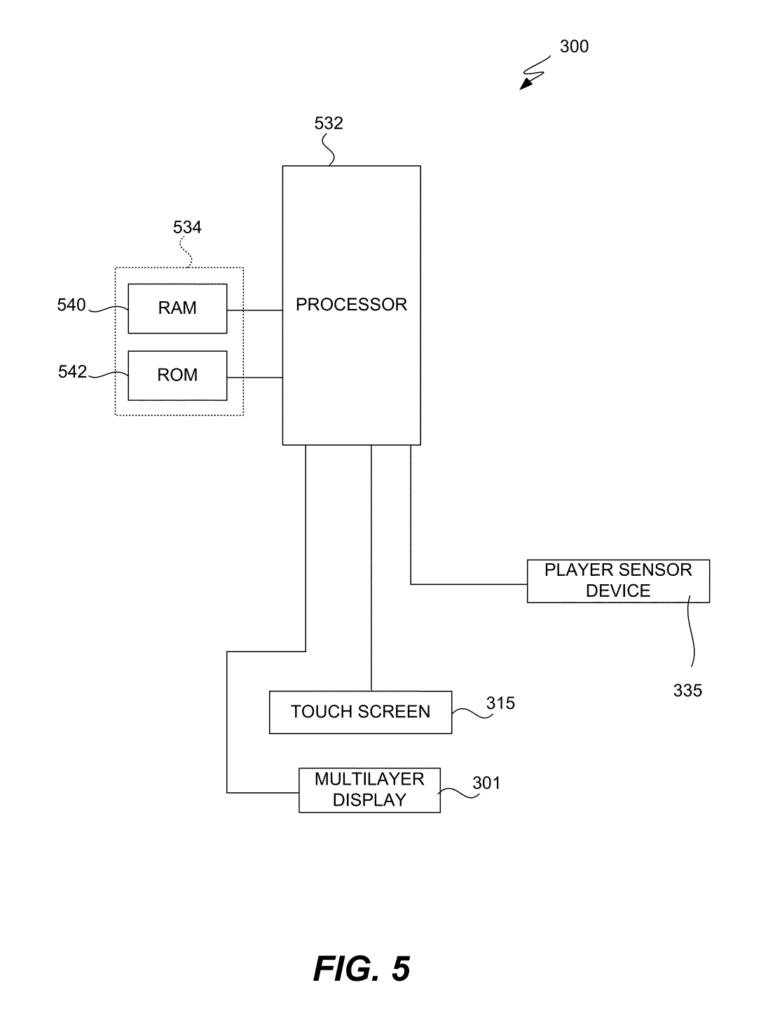

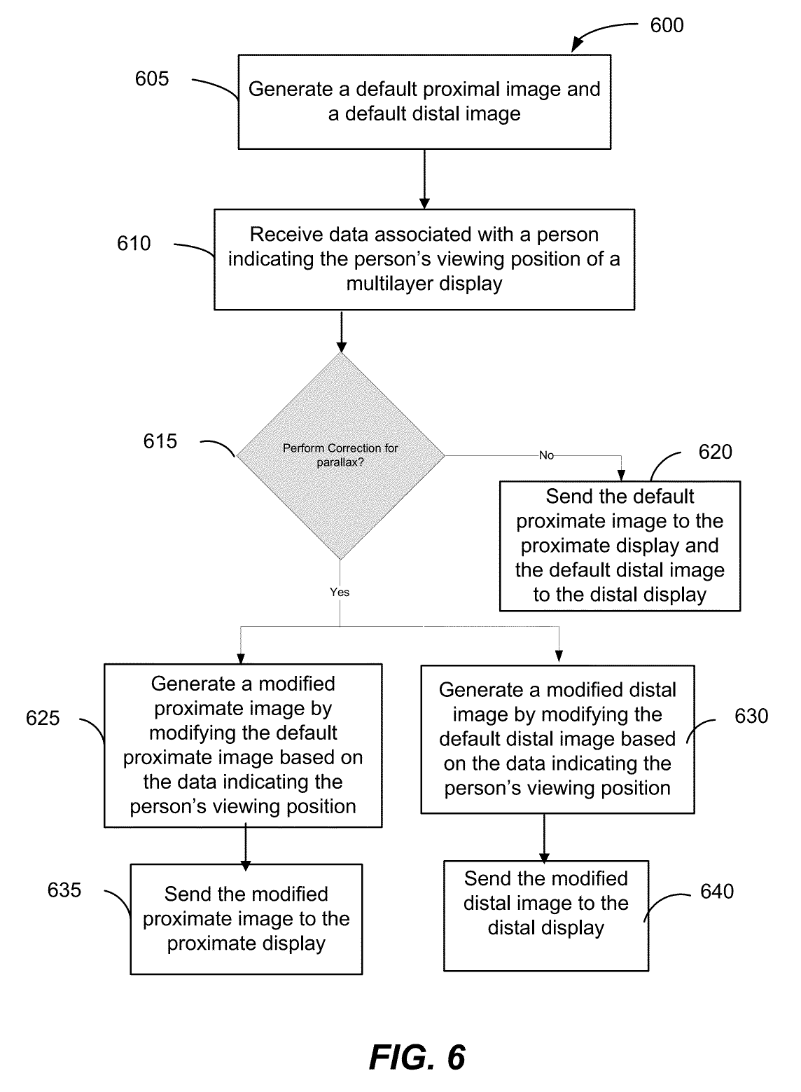

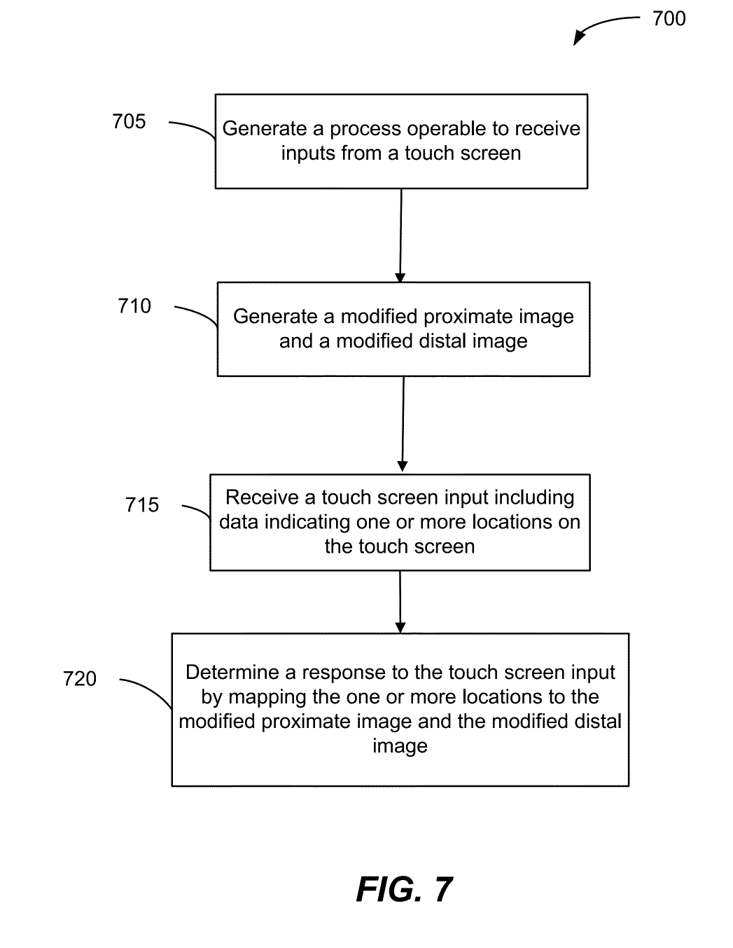

In some implementations, the gaming machine 300 may include one or more processors and memory that cooperate to control gaming machine functions. FIG. 5 illustrates an example control system for the gaming machine 300, configured in accordance with some implementations. A processor 532 may be configured to provide the multilayer display 301 with output video data. Although FIG. 5 shows the processor 532 and memory 534 residing in the gaming machine, it is possible to provide some or all of their functions at a central location such as a network server for communication to a playing station such as over a local area network (LAN), wide area network (WAN), Internet connection, microwave link, and the like. Furthermore, those of skill in the art will appreciate that any of the functions performed by the processor 532 may be allotted to various physical processor devices or a processing system including one or more logic devices (i.e. “one or more processors”). In some implementations, the one or more processors may also be configured to perform the methods 600 and 700 shown in FIGS. 6 and 7, respectively. It will be appreciated that a processor may be configured to perform the functionality described herein by executing instructions embodied in program code stored in a memory, such as the memory 534.

The memory 534 may include one or more memory modules, flash memory or another type of conventional memory that stores executable programs that are used by the processing system. The memory can include any suitable software and/or hardware structure for storing data, including a tape, CD-ROM, floppy disk, hard disk or any other optical or magnetic storage media. The memory may also include a) random access memory (RAM) 540 for storing event data or other data generated or used during a particular game and b) read only memory (ROM) 542 for storing program code that controls processes on the gaming machine.

In some implementations, the processor 532 may be communicatively coupled with the player sensor device 335. The player sensor device may be configured to detect data associated with a person indicating the person's viewing position of the multilayer display. For instance, the player sensor device may be an optical sensor configured to detect data associated with the location of the player's head and/or eyes. One example of a suitable player sensor device is a consumer camera with face, eye and smile detection. These inexpensive cameras can be coupled with facial recognition software to identify facial features including eye detection and gaze direction. In another example, Time of Flight (TOF) CMOS sensors such as Canesta and PrimeSense that detect three dimensional objects by measuring the time pulsed light is reflected from an object may be used as the player sensor device.

In some implementations, the player sensor device 335 may be located under the multilayer display 301 and directed to capture an image or position of the player 305 as shown in FIG. 3. However, those of skill in the art will appreciate that other placements are possible. For instance, the player sensor device may be located above the multilayer display or to either the left or right side of the multilayer display.

In some implementations, as discussed, the gaming machine 300 may include the touch screen 315 shown in FIGS. 3 and 5. The processor may be configured to receive a touch screen input from the touch screen. The touch screen input may be used to operate the gaming machine, such as when the player touches one of the plurality of player selectable buttons 402, 404, 406 and 408 shown in FIG. 4.

Adjusting for the Parallax Effect

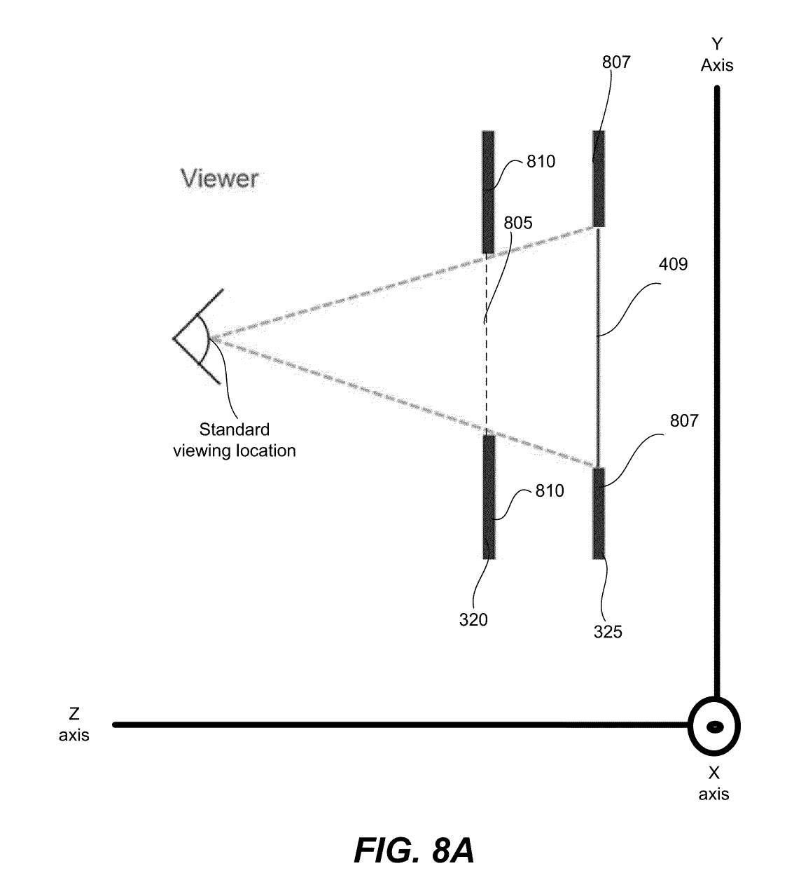

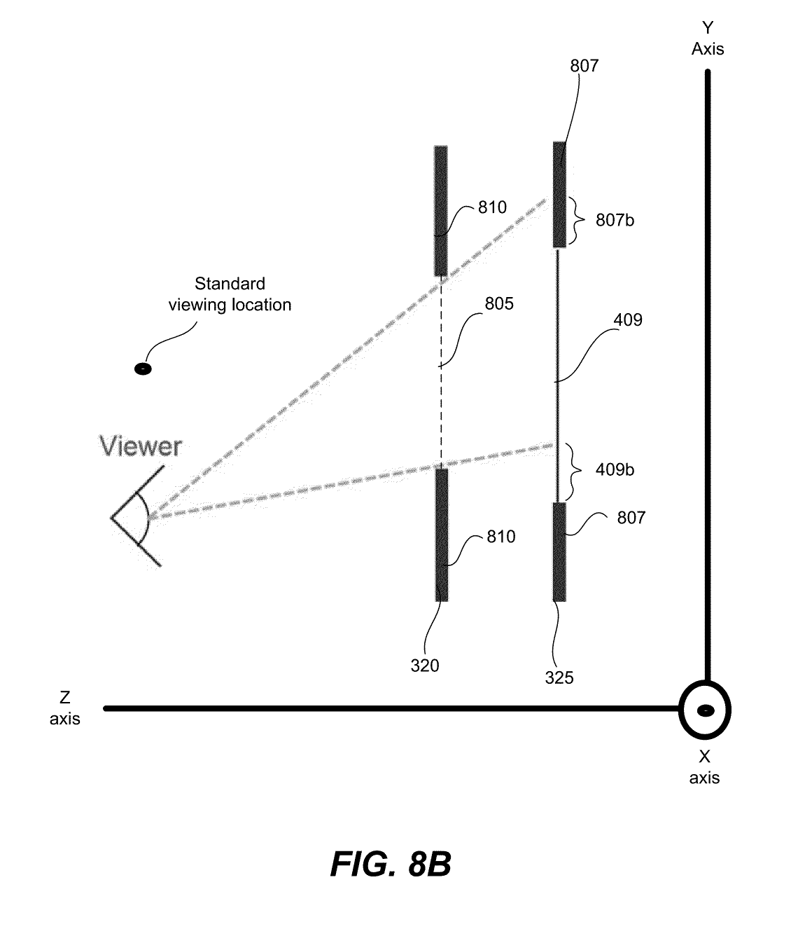

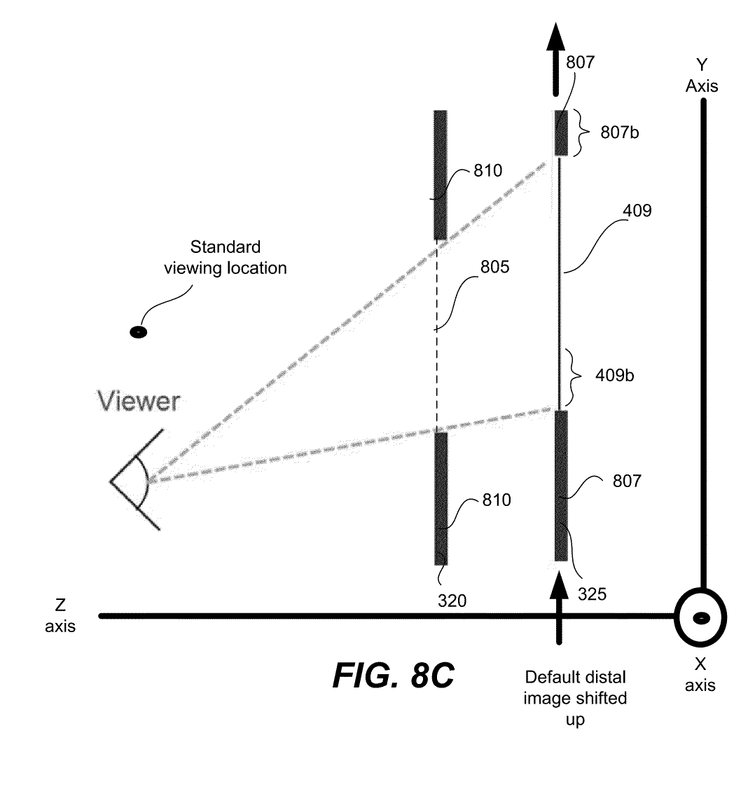

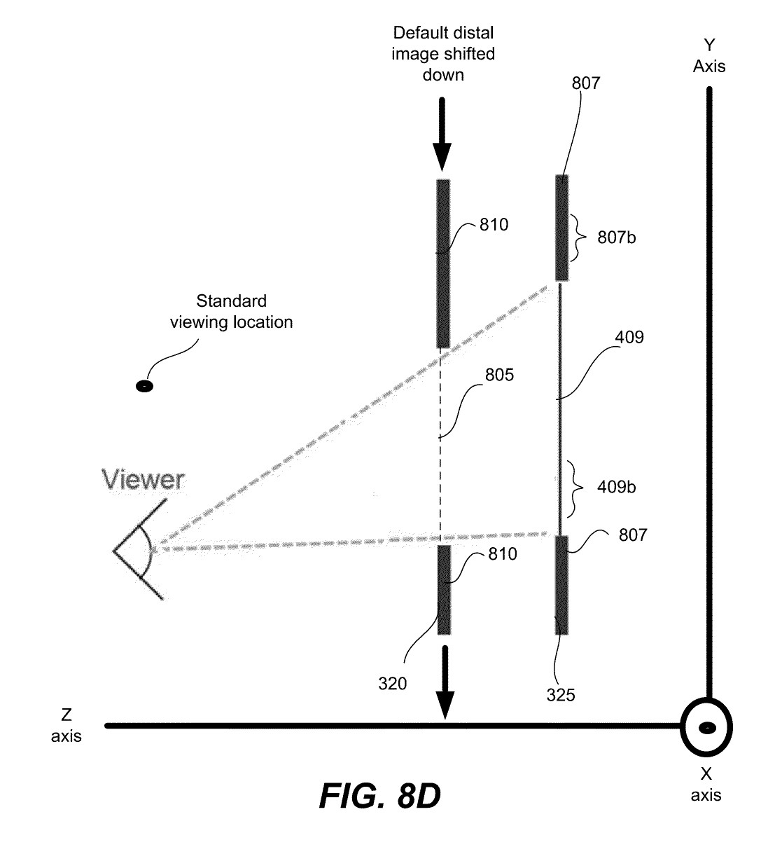

Those of skill in the art will appreciate that a conventional multilayer display without parallax removal capability will produce a non-parallax image only at a predetermined standard viewing location. The standard viewing location may be a location from which a manufacturer of the gaming machine might expect or desire the player to view the multilayer display. With reference to FIG. 4, the standard viewing location is typically configured to be at the middle of the multilayer display along an X-axis and the middle of the multilayer display along a Y-axis. With reference to FIG. 8A, the standard viewing location is further typically configured to be at a comfortable distance for the viewer away from the multilayer display (e.g., 0.5 meters) along a Z-axis.

The conventional multilayer display without parallax removal capability will create the parallax effect when the player's head position and/or eye position deviates from the standard viewing location. For instance, the person may move his head horizontally from the standard viewing location (i.e., left or right of the center of the multilayer display along the X-axis), vertically from the standard viewing location (i.e., above or below the center of the multilayer display along the Y-axis), or away or toward from the standard viewing location (i.e., moving away or toward the multilayer display along the Z-axis).

FIG. 6 shows a flowchart of an example of a method 600 for correcting parallax on a multilayer display, performed in accordance with some implementations. In block 605, the one or more processors of the gaming machine generate a default proximal image and a default distal image. In one example, the one or more processors generate a process operable to provide wager game play on the gaming machine. This process may produce video data that provides for the default proximal image and the default distal image. In some implementations, the default proximate image and the default distal image are generated so that the player does not see a parallax effect at the standard viewing location.

In block 610, the one or more processors receive data indicating the person's viewing position of the multilayer display. The data may be detected by the player sensor device 335 and sent to the one or more processors. Typically, the data associated with the person comes from a player on the gaming machine. The player may be interacting with the various devices of the gaming machine while looking at the multilayer display.

In block 615, the one or more processors determine whether a correction for parallax should be performed based on the data indicating the person's viewing position of the multilayer display. In one example, the person's viewing position is so close to the standard viewing position that corrections may not be required. Therefore, the one or more processors may be configured such that corrections are only performed when the person's viewing position is more than a predetermined distance from the standard viewing location. In another example, the person's viewing position is so far from the standard viewing position that corrections would cause images to appear outside of viewable portions of the multilayer display. Therefore, the one or more processors may further be configured such that corrections are only performed when the person's viewing position is less than a predetermined distance from the standard viewing location.

If in block 615 it is determined that no correction is needed, the method may proceed to block 620, wherein the default proximate image is sent to the proximate display and the default distal image is sent to the distal display.

If in block 615 it is determined that no correction is needed, the method may proceed to block 625 or to block 630. In block 625, the one or more processors generate a modified proximate image by modifying the default proximate image based on the data indicating the person's viewing position. In block 630, the one or more processors generate a modified distal image by modifying the default distal image based on the data indicating the person's viewing position.

Blocks 625 and 630 share similar and related techniques that are described together. In some implementations, both block 625 and 630 may be performed responsive to determining a correction is needed in block 615. In some implementations, modifying the default proximate image may include adjusting the position or size of graphics on the default proximate image. Similarly, modifying the default distal image may include adjusting the position or size of graphics on the default distal image.

FIG. 8A shows a representation of the player's line of sight of the proximate display 320 and the distal display 325 from the standard viewing location. The proximate display 320 may include a transparent or translucent (“transparent regions 805”) and graphic regions 810. In some implementations, the distal display 325 may include the spinning reels 409 and backlighting regions 807. The player is able to fully see the spinning reels 409 on the distal display 325 through the transparent regions 805. The graphic regions 810 may be backlit by the backlighting regions 807, lighting up the graphic regions 810. In some implementations, the distal display 325 may be configured to display white in the backlighting regions 807 to backlight the graphic regions 810.

In some implementations, the distal display 325 may include a backlighting device that back lights the distal display. The backlighting regions 807 of the distal display 325 may be turned transparent or to display white, allowing the backlighting device to shine light through the backlighting regions 807 of the distal display 325 to backlight the graphic regions 810 of the proximate display 320.

X-Y Axis Corrections

When the player moves his head from the standard viewing location along the X or Y axis (X and Y axis shown in FIG. 4), the parallax effect causes images on proximate display 320 to appear shifted relative to images on the distal display 325 from the player's new viewing location, resulting in a misaligned composite image for the player. In an example shown in FIG. 8B, the player has moved below the standard viewing position along the Y axis, causing the default proximate image on the proximate display 320 to appear shifted up relative to the default distal image on the distal display 325. Therefore, unless adjustments to the default images are made, the player will improperly see backlighting region 807b of the default distal image on the distal display 325 and not see spinning reels region 409b of the default distal image on distal display 325.

The following are example techniques that may be used alone or in combination for Y axis corrections (i.e., the player has moved a first direction along the Y axis): 1) shifting the default distal image in the direction opposite the first direction along the Y-axis, 2) shifting the default proximate image in the first direction along the Y-axis, 3) growing the default distal image relative to the default proximate image along the Y-axis, 4) shrinking the default proximate image relative to the default distal image along the Y-axis.

As shown in FIG. 8C, one example of a Y axis correction for when the player has moved below the standard viewing position along the Y axis may be to shift the default distal image up along the Y-axis while keeping the default proximate image.

In another example shown in FIG. 8D, the default proximate image may be shifted down along the Y axis while keeping the default distal image unchanged.

As illustrated in FIGS. 8C and 8D, making either correction results in the player no longer improperly seeing backlighting region 807b of the default distal image on the distal display 325. Furthermore, the player will also now see the spinning reels region 409b of the default distal image on distal display 325.

In a third example, the default distal image may be shifted up and the default proximate image may be shifted down. This technique may be desirable where, for example, a player has shifted his viewing position so far below the standard viewing position along the Y axis that adjusting only the default distal image causes some portion the default distal image to shift outside of viewable portions of the distal display 325.

The type and the magnitude of any corrections may be determined with various techniques. For instance, algorithms such as Algorithms such as Fisherface or Eigenface may be used to evaluate facial input patterns and track the player's head and eye position. This data may then be used to determine the player's view of the multilayer display and the types and magnitudes of any corrections.

Similar techniques apply to X axis corrections (i.e., the player has moved a first direction along the X axis), such as: 1) shifting the default distal image in the direction opposite to the first direction along the X-axis, 2) shifting the default proximate image in the first direction along the X-axis, 3) growing the default distal image relative to the default proximate image along the X-axis, 4) shrinking the default proximate image relative to the default distal image along the X-axis.

Z Axis Corrections

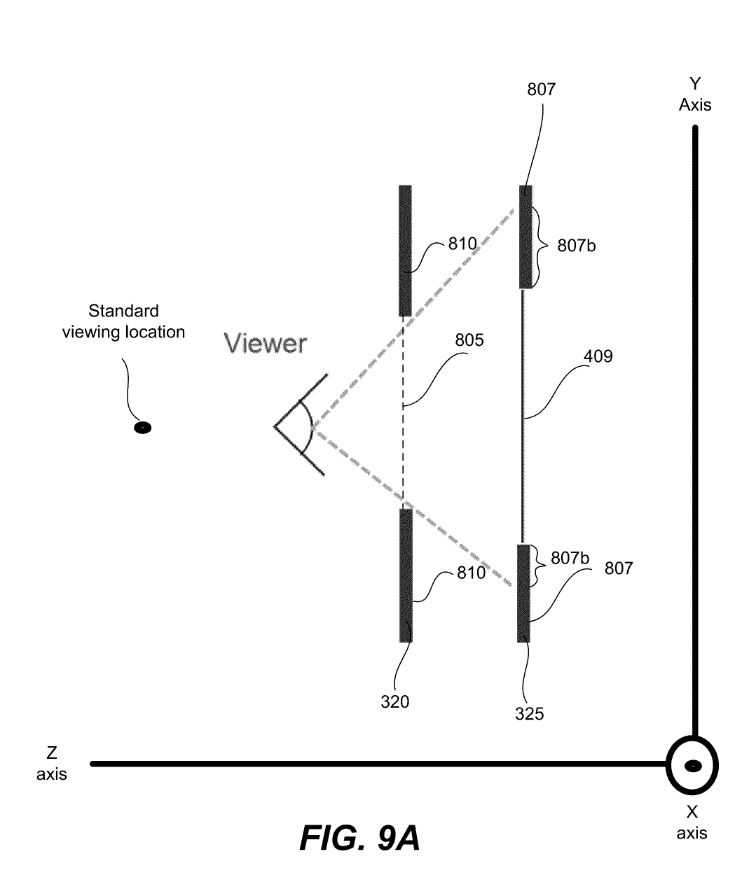

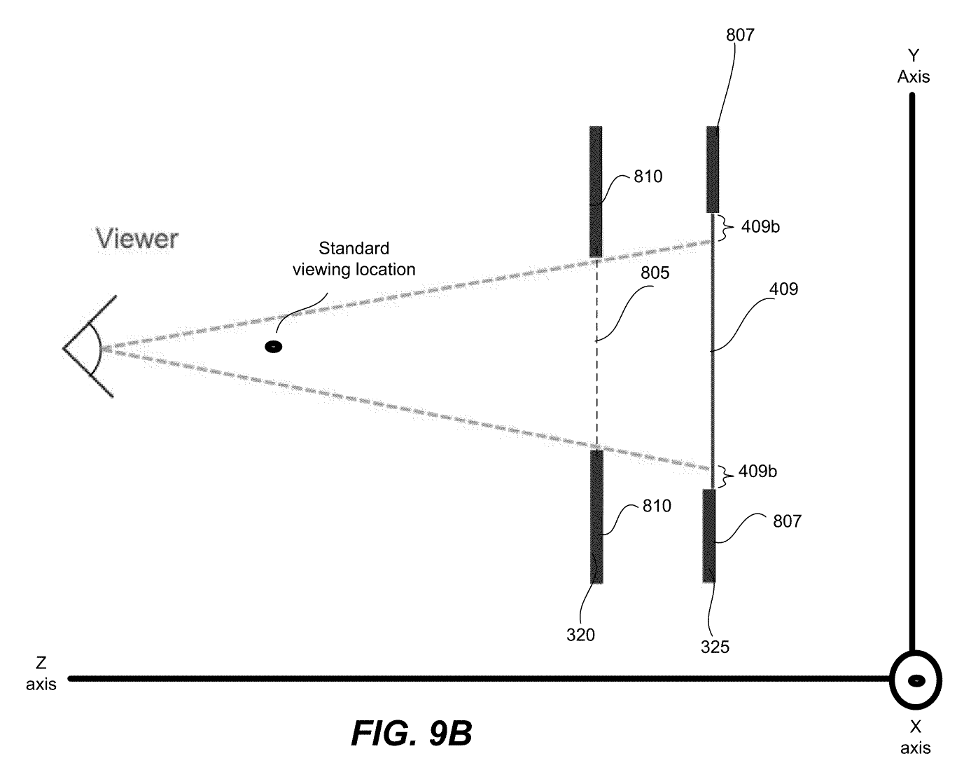

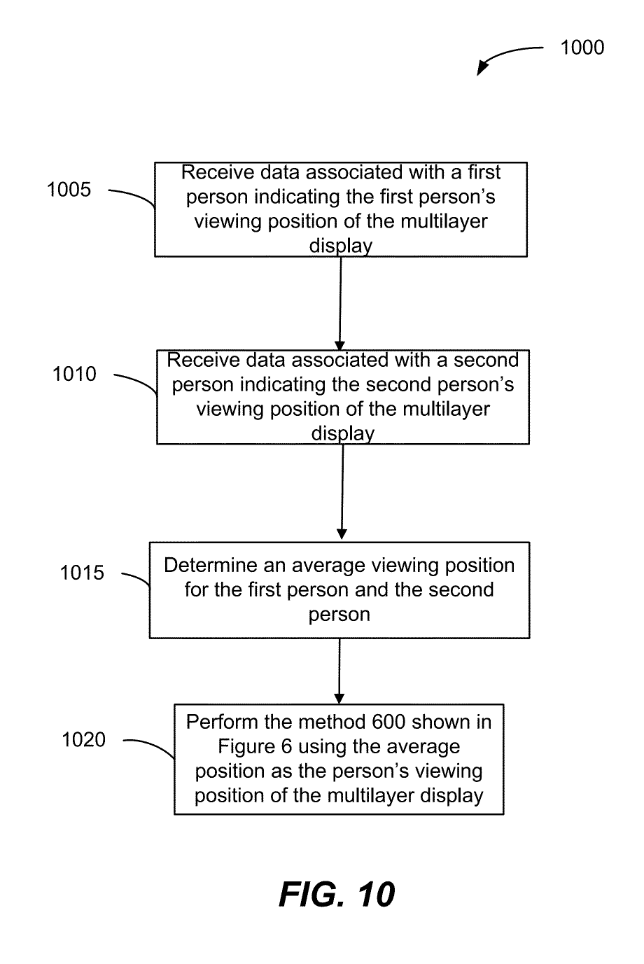

When the player moves his head from the standard viewing location along the Z axis (Z axis shown in FIG. 9A), the parallax effect causes the default proximate image on proximate display 320 to appear to grow (when moving toward the multilayer display along the Z axis) or to shrink (when moving away from the multilayer display along the Z axis) more rapidly than the default distal image on the distal display 325 when the player views the multilayer display from the player's new viewing location. Head movement along the Z axis also result in a misaligned image for the player.

In an example shown in FIG. 9A, the player has moved from the standard viewing position toward the multilayer display along the Z axis. As shown in FIG. 9A, this causes the default proximate image to appear larger relative to the default distal image at the new position. Therefore, unless adjustments to the layered displays are made, the player will improperly see backlighting regions 807b of the default distal image the distal display 325.

The following are example techniques that may be used alone or in combination for Z axis corrections when the player has moved toward the multilayer display along the Z axis: 1) growing the default distal image relative to the default proximate image along the X-axis and the Y-axis, 2) shrinking the graphic on the default proximate image relative to the graphic on the default distal image along the X-axis and the Y-axis.

In an example shown in FIG. 9B, the player has moved from the standard viewing position in a direction away from the multilayer display along the Z axis. As shown in FIG. 9B, this causes the default proximate image to appear smaller relative to the default distal image at the new position. Therefore, unless adjustments to the layered displays are made, the player will not see spinning reels regions 409b of the default distal image the distal display 325.

The following are example techniques that may be used alone or in combination for Z axis corrections when the person has moved away from the multilayer display along the Z axis: 1) growing the default proximate image relative to the default distal image the X-axis and the Y-axis, 2) shrinking the default distal image relative to the default proximate image along the X-axis and the Y-axis.

It will be appreciated that blocks 615 and 620 may each include performing X-axis, Y-axis and Z-axis corrections in generating the modified proximate image and the modified distal image respectively, depending on the player's viewing position of the multilayer display and the selected method of correcting for parallax.

Returning to FIG. 6, in block 635, which is performed when block 625 is performed, the one or more processors may send the modified proximate image to the proximate display. One example of a graphic that may be presented by the modified proximate image includes the spinning reels shown in FIG. 4. If block 625 is performed, but block 630 is not, then the default proximate image may also be sent to the proximate display in block 635.

In block 640, which is performed when block 630 is performed, the one or more processors may send the modified distal image to the distal display. One example of a graphic that may be presented by the modified distal image includes the virtual reel glass shown in FIG. 4. If block 630 is performed, but block 625 is not, then the default distal image may also be sent to the distal display in block 635.

The modified proximate image and/or the modified distal image, when shown on the proximate display and the distal display respectively, combine to provide a composite image on the multilayer display. As discussed detail below above, the composite image is such that there is no parallax effect for the person viewing the multilayer display at the position determined by the data associated with the person indicating the person's viewing position of the multilayer display received in block 610.

In some implementations, the processor may further be configured such that a touch screen, such as the touch screen 315 shown in FIG. 3, works in conjunction with adjustments to the multilayer displays. FIG. 7 shows a flowchart of an example of a method 700 for correcting parallax on a multilayer display having a touch screen, performed in accordance with some implementations.

In block 705, the one or more processors generate a process operable to receive inputs from a touch screen, such as touch screen 315 shown in FIG. 3. Touch screen inputs may be used by a player to provide commands to the gaming machine. In one example, the user interacts with a wager game being provided by the one or more processors using the touch screen.

In block 710, the one or more processors generate a modified proximate image and a modified distal image. The example method 600 described above with reference to FIG. 6 is one example of techniques that may be performed in block 710. In some implementations, only the modified proximate image is generated in block 710. In some implementations, only the modified distal image is generated in block 710.

In block 715, the one or more processors receive a touch screen input. The touch screen input may be provided by the player. Typically, the touch screen input includes data indicating a location on the touch screen where the player has touched. In some implementations, the touch screen input may also include multi-touch data indicating more than one location on the touch screen where the player has touched.

In block 720, the one or more processors determine a response to the touch screen input by mapping the one or more locations to the modified proximate image and the modified distal image. For instance, if a button image is shifted on the proximate display to remove the parallax effect, the one or more processors may be configured to register a press of the button when the player touches the button at the shifted location but not when the player touches a location from which the button has been shifted away. In some implementations, only the modified proximate image was generated in block 710, and the response to the touch screen input in block 720 may be determined by mapping the one or more locations to the default distal image and the modified proximate image. In some implementations, only the modified distal image was generated in block 710, and the response to the touch screen input in block 720 may be determined by mapping the one or more locations to the default distal image and the modified proximate image.

In some implementations, the example methods 600 and 700 may be repeated to ensure that the player receives a parallax-free image on the multilayer display throughout the gaming session despite some changes to the player's head movements or changes to viewing location.

Furthermore, should the person move, new data associated with the person may be received from the player sensor device. The new data may be used to adjust the data sent to the layered displays such that there is no parallax effect for the person at the new position. Therefore, the image is such that there is no parallax effect regardless of any changes to the person's viewing position of the multilayer display.

Adjusting for the Parallax Effect for Multiple Viewers

The multilayer display may be viewed by a plurality of persons. For instance, a first person may be playing the wager game at a first location while a second person may be viewing the wager on the multilayer display at a second location.

FIG. 10 shows a flowchart of an example of a method 1000 for substantially correcting parallax on a multilayer display for multiple viewers, performed in accordance with some implementations. It will be appreciated that each viewer of the multilayer display will have a different viewing position. For instance, if no parallax correction is performed, one viewer may be substantially more affected by a parallax effect than a second viewer (e.g., the second viewer is near the standard viewing location but the first player is not). The method 1000 is an imperfect technique of parallax correction that provides a compromise so that both the first viewer and the second viewer see substantially the same level of parallax effect. If the first viewer and second viewer have viewing locations that are relatively close, neither should see a noticeable parallax effect. While the method 1000 is described for two viewers, the technique applies equally for substantially correcting parallax on a multilayer display for more than two viewers.

In block 1005, the one or more processors of the gaming machine receive data associated with the first person indicating the first person's viewing position of the multilayer display. In block 1010, the one or more processors receive data associated with the second person indicating the second person's viewing position of the multilayer display. The data may be detected by the player sensor device and sent to the one or more processors.

In block 1015, the one or more processors determine an average position for the first person and the second person. In some implementations, this may be implemented by determining (x,y,z) coordinate locations for the first person and the second person and averaging them. In block 1020, the one or more processors perform the method 600 using the average position as the person's viewing position of the multilayer display. Those of skill in the art will appreciate that while the method 1000 involves two persons, the techniques provided apply to a situations involving more than two persons.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

It will be understood that unless features in any of the above-described implementations are expressly identified as incompatible with one another or the surrounding context implies that they are mutually exclusive and not readily combinable in a complementary and/or supportive sense, the totality of this disclosure contemplates and envisions that specific features of those implementations can be selectively combined to provide one or more comprehensive, but slightly different, technical solutions. It will therefore be further appreciated that the above description has been given by way of example only and that modifications in detail may be made within the scope of the invention.

What is claimed is:

1. A gaming machine comprising:
a multilayer display including:
a proximate display, and
a distal display;
a player sensor configured to detect data associated with a person indicating the person's viewing position of the multilayer display;
one or more processors configured to:
provide wager game play on the gaming machine,
generate a default proximate image,
generate a default distal image,
receive the data indicating the person's viewing position of the multilayer display,
determine whether a correction for a parallax effect is required based on the data indicating the person's viewing position,
responsive to determining the correction is required, either:
(a) generate a modified proximate image by modifying the default proximate image based on the data indicating the person's viewing position, and
send the modified proximate image to the proximate display, or
(b) generate a modified distal image by modifying the default distal image based on the data indicating the person's viewing position, and
send the modified distal image to the distal display; and
wherein the proximate display and the distal display provide a composite image on the multilayer display without the parallax effect for the person at the person's viewing position of the multilayer display.

2. The gaming machine of claim 1, wherein the one or more processors are further configured to:
responsive to determining the correction is required, generate the modified proximate image by modifying the default proximate image based on the data indicating the person's viewing position, send the modified proximate image to the proximate display, generate the modified distal image by modifying the default distal image based on the data indicating the person's viewing position, and send the modified distal image to the distal display.

3. The gaming machine of claim 1, wherein the one or more processors are further configured to:
generate the modified proximate image by adjusting the default proximate image's position or size.

4. The gaming machine of claim 1, wherein one or more processors are further configured to:
generate the modified distal image by adjusting the default distal image's position or size.

5. The gaming machine of claim 1, wherein the player sensor is an image sensor such as an optical sensor, TOF camera, ultra-sonic, infrared, laser, or radar.

6. The gaming machine of claim 1, wherein the data associated with the person includes data associated with the person's head location.

7. The gaming machine of claim 1, wherein the data associated with the person includes data associated with the person's eye location.

8. The gaming machine of claim 1, wherein the data associated with the person includes data associated with the person's gaze direction.

9. The gaming machine of claim 1, wherein the modified proximate image includes a graphical representation of a virtual reel glass and the modified distal image includes a graphical representation of spinning reels.

10. The gaming machine of claim 1, further comprising a touch screen, and wherein the one or more processors are further configured to:
receive a touch screen input including data indicating one or more locations on the touch screen; and
determine a response to the touch screen input by mapping the one or more locations to the modified proximate image or the modified distal image.

11. The gaming machine of claim 2, further comprising a touch screen, and wherein the one or more processors are further configured to:
receive a touch screen input including data indicating one or more locations on the touch screen; and
determine a response to the touch screen input by mapping the one or more locations to the modified proximate image and the modified distal image.

12. A method for correcting for parallax effects on a gaming machine including a multilayer display having a proximate display and a distal display, comprising:
generating, with one or more processors, a default proximate image;
generating, with the one or more processors, a default distal image;
receiving data associated with a person indicating the person's viewing position of the multilayer display from a player sensor;
determining whether a correction for a parallax effect is required based on the data indicating the person's viewing position,
responsive to determining the correction is required, either:
(a) generating, with the one or more processors, a modified proximate image by modifying the default proximate image based on the data indicating the person's viewing position, and
sending the modified proximate image to the proximate display, or
(b) generating, with the one or more processors, a modified distal image by modifying the default distal image based on the data indicating the person's viewing position, and
sending the modified distal image to the distal display; and
wherein the proximate display and the distal display provide a composite image on the multilayer display without a parallax effect for the person at the person's viewing position of the multilayer display.

13. The method of claim 12, further comprising:
responsive to determining the correction is required:
generating, with the one or more processors, the modified proximate image by modifying the default proximate image based on the data indicating the person's viewing position,
sending the modified proximate image to the proximate display,
generating, with the one or more processors, the modified distal image by modifying the default distal image based on the data indicating the person's viewing position, and
sending the modified distal image to the distal display.

14. The method of claim 12, further comprising:
generating the modified proximate image by adjusting the default proximate image's position or size.

15. The method of claim 12, further comprising:
generating the modified distal image by adjusting the default distal image's position or size.

16. The method of claim 12, wherein the player sensor is an image sensor such as an optical sensor, TOF camera, ultra-sonic, infrared, laser, or radar.

17. The method of claim 12, wherein the data associated with the person includes data associated with the person's head location.

18. The method of claim 12, wherein the data associated with the person includes data associated with the person's eye location.

19. The method of claim 12, wherein the data associated with the person includes data associated with the person's gaze direction.

20. The method of claim 12, further comprising:
receiving a touch screen input from a touch screen, the touch screen input including data indicating one or more locations on the touch screen; and
determining a response to the touch screen input by mapping the one or more locations to the modified proximate image or the modified distal image.

21. The method of claim 13, further comprising:
receiving a touch screen input from a touch screen, the touch screen input including data indicating one or more locations on the touch screen; and
determining a response to the touch screen input by mapping the one or more locations to the modified proximate image and the modified distal image.

22. The method of claim 13, wherein the modified proximate image includes a graphical representation of a virtual reel glass and the modified distal image includes a graphical representation of spinning reels.

23. A gaming machine comprising:
a multilayer display including:
a proximate display, and
a distal display;
a player sensor configured to:
detect first data associated with a first person indicating the first person's viewing position of the multilayer display, and
detect data associated with a second person indicating the second person's viewing position of the multilayer display; and
one or more processors configured to:
provide wager game play on the gaming machine,
generate a default proximate image,
generate a default distal image,
receive the first data indicating the first person's viewing position of the multilayer display,
receive the second data indicating the second person's viewing position of the multilayer display,
determine an average viewing position using the first data and the second data;
determine whether a correction for a parallax effect is required based on the average viewing position;
responsive to determining the correction is required, either:
(a) generate a modified proximate image by modifying the default proximate image based on the average viewing position, and
send the modified proximate image to the proximate display, or
(b) generate a modified distal image by modifying the default distal image based on the average viewing position, and
send the modified distal image to the distal display; and
wherein the proximate display and the distal display provide a composite image on the multilayer display without a parallax effect for a person at the average viewing position.
